(19) United States
(12) Patent Application Publication
(10) Pub. No.: US 2015/0259080 A1
(43) Pub. Date: Sep. 17, 2015

(54) Space station telescope, Harrier-type landing on moon

(71) Applicant: Michael Lewis Moravitz, Fairfax, VA (US)

(72) Inventor: Michael Lewis Moravitz, Fairfax, VA (US)

(21) Appl. No.: 14/545,266

(22) Filed: Mar. 11, 2014

(51) Int. Cl. B64G 1/10; G02B 23/16; B64G 1/66

(52) U.S. Cl. CPC B64G 1/105; B64G 1/66; G02B 23/16; B64G 2001/1092; B64G 2001/1057

(57) ABSTRACT

New versions of the space shuttle or space plane could be engineered with vertical landing capability to undertake missions to the Moon and to Mars.

The next generation of manned space shuttles or space planes might be fitted to land on the Moon or nearby astronomical bodies with a “Harrier-Jet” vertical landing capability. Instead of landing horizontally like the space shuttle and unmanned mini-shuttle, my design would allow the space flight vehicle to land vertically—like the British Harrier jet or original NASA moon lander. This would mean the plane would not run into obstacles on the Moon or other astronomical bodies, lessening the danger and allowing the vehicle to land in many more locations. In fact, horizontal landings on the Moon, given its surface conditions, might be impossible with current technology. NASA or private engineers might need to look at vertical landing systems and re-engineer current vehicles for possible Moon missions or missions to Mars, asteroids, or other astronomical bodies. This could save overall expenses if the U.S. government and its international partners decides on such future manned missions.

In addition to the current Kepler observatory and the Webb platform now being built to replace the Hubble space telescope, perhaps NASA and its international partners could mount a space telescope on the International Space Station, the ISS. This would provide a human portal above the atmosphere that could observe the universe according to scientific needs and more precision that telescopes on Earth. This would add to the missions of the space station crews, and perhaps add to the technical and astronomical knowledge of all crew members, including the United States, Russians, Europeans, and Japanese. There would also be many ways to use the images and research from the space telescope the highlight the missions aboard the International Space Station or future stations. The ISS is due to go off line in 2020, and the space telescope might not be deployable by then, but perhaps a future space station could use one. NASA might even consider a large orbiting space telescope that could be manned continuously by astronauts, focusing on astronomical observations of the universe.

1) Builds on patents for the space shuttle;

2) Space X Dragon Space plane;

3) the Moon vertical landing system from the original Apollo missions;

4) Harrier Jet vertical landing systems.
